(19) United States
(12) Patent Application Publication
(10) Pub. No.: US 2024/0375709 A1
(43) Pub. Date: Nov. 14, 2024

(54) IMPROVED STEERING SYSTEM, A STEERING ARRANGEMENT AND A METHOD FOR STEERING CONTROL

(71) Applicants: Johan HULTÉN, Göteborg (SE); Jochen POHL, Partille (SE); Lars MARKSTRÖM, Västra Frölunda (SE)

(72) Inventors: Johan HULTÉN, Göteborg (SE); Jochen POHL, Partille (SE); Lars MARKSTRÖM, Västra Frölunda (SE)

(21) Appl. No.: 18/779,290

(22) Filed: Jul. 22, 2024

Related U.S. Application Data
(63) Continuation of application No. PCT/SE2023/050157, filed on Feb. 22, 2023.

(30) Foreign Application Priority Data
Mar. 17, 2022 (SE) 2250335-3

(51) Int. Cl. B62D 6/00

(52) U.S. Cl. CPC B62D 6/008

(57) ABSTRACT

The present invention relates to a power assisted steering system (100) for a vehicle or similar, comprising a steering arrangement (1), a steering shaft (2) connected thereto, steering elements (101,101), an electric steering assistance actuator (8) for controlling the steering elements (101,101) and an Electronic Control Unit (ECU) (5) comprising transformation functions for transformation of input information received by means of a number of sensors (16,4,13,14, 15, 17) to command signals for execution in steering feel control and steering position control functions arranged to provide actuator activation signals to steering arrangement actuator (3) controlling feedback to the steering arrangement (1) and/or to the steering actuator (8) controlling one or more steering elements (101,101) to create and/or tune steer effects and/or create desired extended feedback.

### TECHNICAL FIELD

The present invention relates to a steering system having the features of the first part of claim 1. The invention also relates to a steering system arrangement and to a method for steering control having the features of the first part of claims 17 and 20 respectively, and to a vehicle comprising such a steering system.

### BACKGROUND

Traditionally the steering system of e.g. a road vehicle comprises a mechanical connection between the steering wheel and the steerable wheels. Other steering systems, not having a mechanical connection, are also known, which often are referred to as SbW, steer-by-wire, systems. In a SbW, steer-by-wire, system one or more sensors register physical properties and generate signals. Examples on such properties are forces and movements of the steering wheel or some other steering input device, such as a yoke or joystick or other means. These generated signals of registered physical properties can be provided to an ECU, Electronic Control Unit, and transformed by the ECU into a desired action to be provided on the steerable wheels. A power assisted steering actuator that is electrically connected to the ECU and mechanically linked to the steerable wheels will then execute the desired action and apply desired forces to the steerable wheels.

The feedback to the driver is typically provided by means of an electric motor, creating forces and/or movements to the steering wheel, or otherwise transmitted via the mechanical connection.

SbW systems offer many advantages compared to conventional mechanical steering, such as for example allowing energy absorption in collisions, flexible location of the steering wheel, handling of left- and right-hand drive variants, a removable steering wheel, different steering input devices, autonomous drive and advanced driving aid. Also, SbW offer several opportunities for the driving experience itself, e.g. the already known advantages such as variable steering ratio and immunity to road disturbances.

In a conventional steering system having a mechanical connection between the steering wheel and the steered wheels there is a transfer function between steering wheel angle and steered wheel angle determined by the mechanical design. The forces and movements, the feedback, transmitted to the steering wheel from the contact patch of the tyre is also determined by the mechanical design, e. g. steering, suspension geometry, wheels and tyres.

In a SbW system on the other hand the transfer function between steering wheel angle and steered wheel angle is determined by software via an ECU. Also, the forces and movements, the feedback, transmitted to the steering wheel is determined by software via an ECU and an electric feedback motor. It is known to a person skilled in the art what kind of transfer function is needed for the relation between steering wheel angle and steered wheel angle for a basic steering feel such as torque build up in relation to steering wheel angle and thus vehicle response, friction feel, damping feel and returnability.

But in a conventional steering system, with a mechanical connection, also extended steering feedback and steer effects occur, some of which being desired, other undesired, or unrecognised. Such effects can be intentional by the design or occurring by chance or even as a consequence of compromising between different characteristics. A desired extended steering feedback can be when driving on slippery roads, where a torque drop can be sensed in the steering wheel when the steered tires reaches their grip limit. An unwanted extended steering feedback can be the jerks in the steering wheel when driving on a very rough road. On the other hand, small reactions in the steering wheel when driving over minor irregularities in the road can be a desired extended feedback of being connected to the steered wheels.

A desired steer effect can be a stabilising steer effect when breaking in a turn. An undesired steer effect can be a destabilising steer effect when braking during split friction conditions.

In a SbW system, however, such extended steering feedback and steer effects are to a high degree lost since the mechanical connection is removed. The lack of a “real” steering feedback, including extended steering feedback and steer effects, therefore is considered a disadvantage by drivers and by car manufacturers, in particular by car enthusiasts, and premium car manufacturers.

A poor steering feedback is most likely an important factor holding back SbW from being more common in the automotive industry despite many interesting advantages and features. Since the introduction in 2013 there is still only one, production car/brand with SbW technology, and they still offer traditional power steering as well. Today known SbW systems offer the basic feedback to be perfectly drivable, but still leave a lot to desire, in particular for car enthusiasts.

One way of providing extended feedback, which is lost without mechanical connection, is to read the current used by the assistance motor connected to the rack. This current can be interpreted as the torque of the assistance motor and thus the force acting on the steering gear and can then be the source for desired feedback instead of the mechanical connection. It is however a problem to do such a current-to-force interpretation such that it will mimic the mechanical connection in the desired way. Another problem is that even if the current-to-force interpretation is satisfactory, it will not only give the desired feedback but also undesired feedback. It will thus not provide any steering feel advantage over simpler traditional steering arrangements with a mechanical coupling.

Swedish patent application 1951159-1 filed 13 Oct. 2019 discloses a method for creating steer effects for a vehicle using a mechanical connection which is different from a SbW. Also, using a mechanical connection for creation of steer effects sometimes is associated with side effects such as a torque and/or a movement in the steering wheel, and therefore not all desired steer effects are realistic to achieve since such side effects might annoy or disturb a driver. There may also be a risk that a driver counteracts or cancels out desired steer effects.

### SUMMARY

It is therefore an object of the present invention to provide an improved steering system and a steering system arrangement and method for steering control in a steering system respectively through which one or more of the above-mentioned problems can be solved and through which one or more of the shortcomings can be overcome.

It is an object of the present invention to provide an improved power assisted wireless steering system, particularly an improved power assisted Steer-by-Wire (SbW) steering system.

It is a particularly an object to provide a steering system providing improved or enhanced steering feedback and/or through which steering comfort can be enhanced.

More particularly it is an object to provide a steer-by-wire steering system through which steer effects can be created, steering feedback be created without undesired side effects.

More particularly it is an object to provide a steer-by-wire steering system through which desired steer effects can be created, steering feedback be created, without, or with less, accompanying or additional, undesired steering feedback or steering effects.

Further it is a particular object to provide a steer-by-wire steering system through which a desired steering feel can be provided, and most particularly which is capable of providing more properties needed for constituting a good steering feel than so far known steering systems, also under varying circumstances.

It is particularly an object to provide a steering system arrangement providing feedback in a SbW steering system, or in a wireless steering system, through which one or more of the above mentioned objects can be achieved.

Yet another particular object is to provide a vehicle steering system and a steering system arrangement respectively which is attractive and flexible, and also cheap and easy to implement and fabricate.

A particular object is to provide a steering system and a steering system arrangement also satisfying pretentious, demanding drivers desiring a very good steering feel and steering feedback.

Still another object is to a vehicle steering system and a steering system arrangement through which steering safety and steering feel can be improved in a wired, particularly a SbW steering system, or a wireless steering system.

Still further it is a particular object is to provide a vehicle steering method and a vehicle steering system arrangement respectively which is reliable, safe and at the same time provides a good steering feel and steering response (vehicle reaction to steering input) under varying conditions.

It is also an object of the present invention to provide a vehicle with a steering system through which one or more of the above mentioned objects are achieved.

Therefore a steering system as initially referred to is provided which has the characterizing features of claim 1. A steering system arrangement and a method for steering control in a steering system respectively as initially referred to having the characterizing features of the respective independent claims 17 and 20 are therefore also provided as well as a vehicle comprising such a steering system.

Advantageous embodiments are given by the respective appended dependent claims and are described in the detailed description respectively.

It will be appreciated that features of the invention are susceptible to being combined in any combination without departing from the scope of the invention as defined by the accompanying claims.

### BRIEF DESCRIPTION OF THE DRAWINGS

The invention will in the following be further described, in a non-limiting manner, and with reference to the accompanying drawings, in which:

FIG. 1. schematically illustrates a vehicle steering system according to one embodiment of a steering system according to the present invention,

FIG. 2 is a schematic block diagram of an ECU with SPC and SFC functions as in the embodiment shown in FIG. 1,

FIG. 3. schematically illustrates a vehicle steering system according to a second embodiment of the present invention, and

FIG. 4 is a schematic flow diagram illustrating steering control in a steer-by-wire steering system according to the invention.

### DEFINITIONS

For the purposes of describing the present invention, and to facilitate the understanding thereof, the following definitions are given, some of which will be relied upon in the detailed description of advantageous embodiments:

Torque and/or angle reference control (TAC) for SbW comprises steering feel control (SFC) and/or steering position control (SPC), respectively. For the steering feel control, it is the control of the steering-wheel torque that the driver feels that is the subject matter, and in steering position control, it is the control of the road-wheel angles, and specifically for a front-wheel steered vehicle, the control of the front axle road-wheel angle, here referred to as the steering angle (see the definition below).

A steering angle is an angle in the steering system that influences the lateral acceleration or curvature of the vehicle, measured somewhere in the steering system, where such steering angles can be:
The front-wheel angle and in the case for e.g. Ackermann steering, the steering angle is defined as the mean value of the angles of the two front wheels.
The articulation angle of an articulated vehicle.
The rear-wheel steering angle in the case of a rear-wheel steered vehicle.
A combination of the front-wheel angle and the rear-wheel angle in the case of an all-wheel steered vehicle.

A steering position actuator is an actuator which can be used for SPC, i.e. to influence one or more of the steering angle, such as the front wheel steering angle, rear wheel steering angle, the individual steering angles of the wheels, the axle braking torque or force, the wheel braking torque or force, the driving torque or force on the individual axles, the driving torque or force on the individual wheels, the camber angle on each axle, or the camber angle on each wheel.

A specific type of steering position actuator is an angle overlay actuator. An angle overlay actuator is an actuator that is used to achieve a relative angle somewhere in the steering column. Two hardware concepts are dominating the angle overlay actuator scene, namely planetary gears (such as in the BMW concept for “Front Active Steering”) and harmonic drives (such as in the Audi variable steering gear ratio).

A vehicle state is defined as a translational or rotational position, velocity or acceleration, or from these before-mentioned states derived states such as e.g. a vehicle slip angle, which is the angle between the vehicle local x-axis and the vehicle speed vector.

Heavy vehicles and farming vehicles such as e.g. tractors require great steering assistance levels. Therefore, the assistance actuators of today are predominantly hydraulic assistance driven (because the fact that hydraulics has high power density). That means that if one would like greater controllability than standard hydraulic assistance valves result in, for functions such as e.g. Lane Keeping Aid (LKA), it is possible to add an EPS (Electric Power Steering) actuator above or in addition to the HPS (Hydraulic Power Steering) actuator. Therefore, for farming equipment and heavy vehicles, a combination of HPS and EPS is now emerging. The HPS actuator is used to achieve a torque reduction, an assistance, and is therefore called hydraulic assistance actuator.

An actuator is a mechanism or system that is operated mechanically or by an ECU and converts a source of energy, typically electric current, hydraulic fluid pressure, or pneumatic pressure, into a motion, a force or a torque.

Variable Gear Ratio (VGR) or variable steering gear ratio is a function to control the steering gear in such a way that the ratio between the steering wheel and the road wheels follows a defined function, usually speed dependent, but other functions are also possible A torsion-bar torque is a torque measured by the use of a sensor that is sensitive to a twist of a specific torsion bar that is mounted somewhere in the steering column.

A steering-wheel torque is the torque resulting from the force applied by the driver to the steering wheel. This steering-wheel torque is normally approximated by the torsion-bar torque and/or indirectly through monitoring current to a steering feedback actuator.

A driver torque is equal to the steering-wheel torque.

A signal bus is a transmission path on which signals can be read and/or transmitted.

An input signal can for example be the measure of a torque resulting from the force applied by the driver via the steering wheel, measured at the steering wheel or at a component mechanically connected to the steering wheel or a signal from which this quantity can be derived.

An ECU is an electric control unit that is used to read analogue sensor signals and digital signals, that can come over e.g. a signal bus, perform any type of computations, such as e.g. perform a control task and actuate actuators, either via a sent analogue or digital signal or by directly controlling e.g. an electric motor from a motor control stage.

Controllability describes the ability of an external input to move the internal state, an actual value, of a system from any initial state to an arbitrary other final state, a target value, in a finite time interval, thus minimising the difference between the target value and the actual value, i.e. the control error.

A lateral acceleration feedback torque is a torque felt by the driver that corresponds to the lateral acceleration of the vehicle.

A tyre friction torque is the torque generated by friction between the tyres and the road or a model of this friction. When turning a wheel, the friction between the tyre and road must be overcome, being the tyre friction torque.

The mathematical model of the tyre friction torque is a model of an angle or angular speed driven hysteresis. The mathematical model of the tyre also contains a relaxation part such that as the tyre rolls, the torque of the hysteresis will have a relaxation length so that the hysteresis torque decreases with the rolling length of the tyre. The relaxation can preferably be the well-known half-life exponential decay function. The model of the tyre friction is the combination of the hysteresis and the relaxation so that e.g. an increase owing to the hysteresis torque can happen at the same time as the torque decreases owing to the relaxation. The resulting torque of the model is the sum of the two parts.

A steering system friction or a friction torque is the friction of the parts of the components of the steering system or a model of this friction.

The mathematical model of the steering system friction torque is a model of an angle or angular speed driven hysteresis. The maximum torque in the hysteresis can be shaped by a function so that the maximum torque is different on centre compared to off centre.

A damping torque occurs owing to damping of the tyres and the steering system or a model of this damping.

A mathematical model of the damping torque consists of some damping constant times an angular speed or translational speed. The damping constant can be such that the damping has a blow-off, such that the damping constant decreases for great angular or translational speeds. The damping constant can be vehicle speed dependent as well as different for steering outwards compared to inwards. The damping constant can also be a function of the steering-wheel or torsion-bar torque.

A returnability torque comes from the geometry and components of the steering system or a model of the steering system. The returnability torque is a vehicle speed dependent and steering-wheel angle dependent torque.

The above mentioned torque contributions can all be vehicle speed dependent. The torque contributions can also be calculated via mathematical models or sensed via sensors in the vehicle or steering system.

A compensation torque is the sum of the above-mentioned tyre friction torque, the friction torque, the damping torque and the returnability torque. The parts of the compensation torque are calculated from mathematical models of the different torque parts.

A target steering-wheel torque is the sum of the lateral acceleration feedback torque, the above-mentioned tyre friction torque, the friction torque, the damping torque, the returnability torque and extended steering feedback torque.

A vehicle state controller, is defined as a dynamic function for achieving a target state in a vehicle in a controlled manner. That is, to minimise the difference between the target state and the actual state, i.e. the control error, in a controlled way.

A vehicle state actuator, is an actuator that when actuated influences one or several vehicle states. Vehicle state actuators are brakes, engine, controllable four-wheel-drive clutches, controllable differentials, active dampers, electric or hydraulic wheel motors and electrically or hydraulically driven axles.

A target value, reference value or request is a set point for the actuator that is achieved by the use of either a closed loop controller and/or a feed-forward controller.

A vehicle model is a mathematical model that transforms a road-wheel angle and a vehicle speed to a number of vehicle yaw and/or lateral states, e.g. one or more of vehicle yaw rate and acceleration, vehicle lateral speed and acceleration and vehicle body sideslip angle.

Transformation is defined as a mathematical function or lookup table with one input value used to produce one output value. That means that a transformation can be used, with its tuneable parameters, to create a relation between the input value and the output value with arbitrary tuneable shape. A transformation can have time-varying parameters that are even dependent on other values, a so-called gain scheduling, so that the transformation is a function with parameters that themselves are functions. An example of such a transformation is a vehicle state to driver torque relation where the relation is a vehicle speed dependent continuously rising, degressive shaped function.

A transformation unit provides output commands to SFC and/or SPC from input signals received over a sensor and signal interface, e.g. one or more of vehicle state information input signals, signals or sensor values relating to vehicle state, signals or sensor values relating to state of steered elements and/or steering actuators, driver input.

A steering-wheel torque measurement is a torque measured in the steering column or in the steering wheel.

A vehicle axis and coordinate system where X is in the horizontal plane and in the forward direction of travel. Y is in the horizontal plane, perpendicular to X and point to the left. Z points upward.

A steered element state can be the angle the steered element forms with the X axis in the horizontal plane and in the forward direction of the vehicle, or with a longitudinal, horizontal, axis of the vehicle.

### Sensors:

A Torque and Angle Sensor (TAS) is a sensor for sensing torque and angle. It generally provides information about a driver input and/or about subsystem state.

A subsystem is here and in the present application a part or an element or an arrangement of e.g. a vehicle, the state of which can be defined through one or more parameters which can assume different values. An example of a subsystem state is a steering element position and/or a steering element angle and/or a steering element velocity, which parameters (position, angle, velocity) can assume different values.

Another example of a subsystem is steering actuator, which can assume different states, e.g. positions.

A brake pedal position and/or brake pedal force are other examples of (vehicle) subsystem states which can assume different values.

Still other examples of subsystem states are steering arrangement (steering wheel) angle and/or steering arrangement (steering wheel) torque, which can assume different values.

A clutch pedal position and/or a clutch pedal force are still other examples of subsystem states which can assume different values.

Still other examples of subsystem states are accelerator pedal position and/or force are other examples of subsystem states which can assume different values.

An ABS sensor or wheel speed sensor is a sensor measuring wheel speed, e.g. sensing vehicle state and/or subsystem state (e.g. steering (steered) element state and/or steering actuator state), i.e. providing vehicle state information and/or subsystem state information.

A rate gyro sensor measures the angular speed around an axis in yaw, pitch or roll direction, e.g. sensing a vehicle state, providing vehicle state information.

An acceleration sensor measures acceleration in longitudinal, lateral or vertical direction, e.g. sensing a vehicle state, providing vehicle state information.

A position sensor measures the position. It can be a local, regional or world-wide coverage; generally referred to as GPS, e.g. sensing a vehicle state, providing vehicle state information.

A brake pedal sensor sensing the position of the pedal. It generally provides information about a driver input and/or about subsystem state.

A brake pressure sensor measures the pressure in the brake system. It generally provides information about a driver input and/or about subsystem state.

An accelerator pedal sensor, sensing the position of the pedal. It generally provides information about a driver input and/or about subsystem state.

A clutch pedal sensor, sensing the position of the pedal. It generally provides information about a driver input and/or about subsystem state.

It should be clear that the present invention is not limited to the exemplified vehicle states, subsystem states and driver inputs and also not to the exemplified states. Other sensors can be used, the described sensors can be used for sensing other or additional states etc.

### DETAILED DESCRIPTION

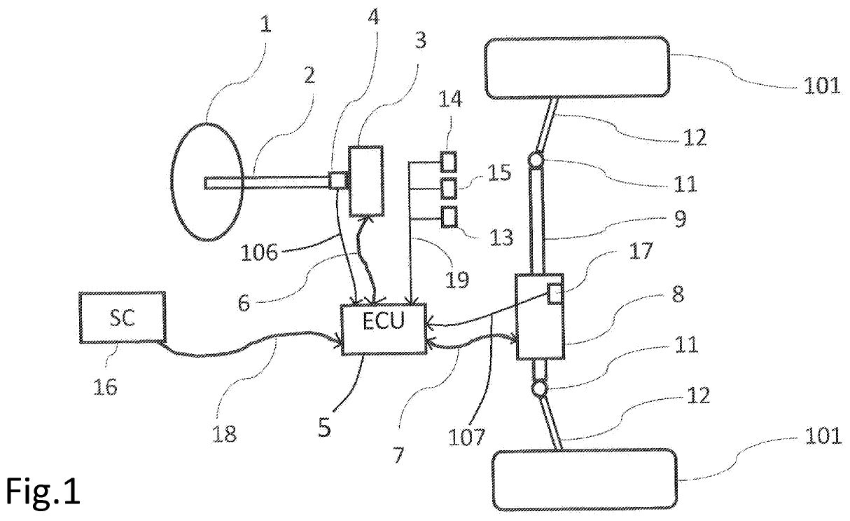

FIG. 1 is a schematic view of a power assisted Steer by Wire vehicle steering system 100 according to a first embodiment of the present invention. It comprises a steering wheel 1, a steering shaft or a steering column 2 to which the steering wheel 1 is connected. The steering shaft 2 is connected to a steering wheel actuator 3 which is controlled by an Electric Control Unit, ECU, 5 via an electric connection 6. The steering system 100 here further comprises a linkage, here comprising a steering rack 9 via ball joints 11 connected to steering rods 12,12 for steering and turning steerable elements, here steerable wheels 101,101 (front and/or rear road wheels).

The implementation of the linkage can take different forms and the inventive concept is not limited to any particular linkage. It further comprises a steering actuator 8 (also denoted an assistance actuator), e.g. comprising an electric actuator or motor or a hydraulic actuator or motor, or in general any electrically controllable actuator.

Steering actuator 8 in the embodiment shown in FIG. 1 is provided between steerable wheels 101,101 and steering wheel 1 via the ECU 5 and a steering wheel actuator 3. It should be clear that in alternative embodiments there may be more than one steering actuator, e.g. there may be one or more actuators also for non-steerable wheels, one for each wheel, or one for each steerable wheel, or one for each wheel etc.

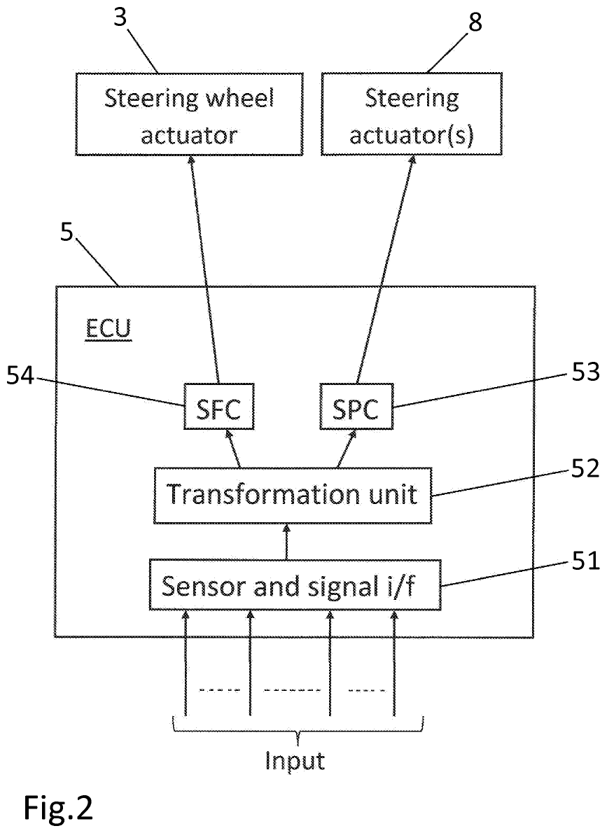

ECU 5 in the shown embodiment comprises a steering feel control function (SFC) (not illustrated in FIG. 1; cf. FIG. 2) connected to the steering wheel actuator 3 and by means of which extended feedback is provided as will be more thoroughly described below, and a steering position control function (SPC), also denoted an angle controller, (not illustrated in FIG. 1; cf FIG. 2) which is connected to the steering actuator 8. To ECU 5 further a number of sensors are connected, here a steering wheel torque and angle sensor 4, electric actuator torque and angle sensor 17, an accelerator position sensor 13, a clutch pedal sensor 14 and a brake pedal sensor 15 and a sensor cluster 16 as will be further described below.

The steering wheel actuator 3 is controlled by the ECU 5 SFC function via, here, electric connection 6. The ECU 5 comprises a transformation unit 54 comprising processing means (see FIG. 2) with transformation or transfer functions generating commands to SPC and SFC to execute the commands and provide actuator activations to steering wheel actuator 3 and to steering actuator 8 respectively to create a desired reaction of the steering wheel 1 and desired steering effects at the steerable wheels 101,101 as will be further explained and exemplified below.

The steering effects are executed by the steering actuator 8 and transmitted to the steerable wheels 101,101 via the steering rack 9, the ball joints 11 and steering rods 12. Thus, the ECU 5 receives sensor signals from the sensors 4, 13, 14, 15, 16, 17 with information about vehicle state and/or steered element state and driver input information as inputs and said input sensor signals are used in the SFC function to control the steering wheel actuator 3 and in the SPC function to control the steering actuator 8 through actuator activation signals.

In the shown embodiment sensor signals to the ECU 5 are here via an electric connection 18 transferred from the sensor cluster 16, via an electrical connection 19 from the clutch pedal sensor 14, the brake pedal sensor 15 and the accelerator sensor position 13, via the electric connection 106 from the steering wheel torque and angle sensor 4, and via an electric connection 107 from the electric actuator torque and angle sensor 17. It should be clear that in alternative embodiments the same connections may be used for communications between the ECU 5 and the steering actuator 8 and between the ECU 5 and the electric actuator torque and angle sensor 17 and between the ECU 5 and the steering wheel actuator 3 and between the ECU 5 and the steering wheel torque and angle sensor 4 respectively. One or more signals may also be transferred via wireless connections or in any other appropriate means.

The steering wheel actuator 3 is via electric connection 6 controlled by the SFC function in the ECU 5 via actuator activations to provide a controlled, desired, torque or a controlled, desired, movement to the steering wheel 1. Torque and/or angle sensor or any torque and angle sensor (TAS) 4 is arranged on the shaft 2 for providing one or more sensor signals (torque and/or angle) to the SFC and to the SPC function, here provided in ECU 5 for steering feel control and for steering position control respectively.

In some embodiments a torsion bar with a torque sensor may be used for measuring the driver torque, i.e. the torque caused by the force applied by the driver on the steering wheel 1, which torque is transmitted through the steering shaft 2 to the torsion bar.

The SPC function of the ECU 5 via connection 7 here controls a current provided to the electric steering actuator 8. In alternative embodiments, e.g. for heavy vehicles, a hydraulic actuator may be used that can be controlled via electric signals.

It should be clear that the number of sensors needed or used is different in different implementations and embodiments. For example, some values needed for input to the ECU can be calculated or deduced from values from other sensors or otherwise obtained, as a non-limiting example, a lateral acceleration can be calculated from a sensor detecting wheel angle and from the vehicle velocity etc. Needed information for providing desired steering effects and/or extended feedback may be available directly via dedicated sensors or otherwise obtainable information, but if further information is needed, sensor values from other sensors can often be used for calculation of the needed information as also mentioned above.

According to the present invention in the ECU 5 transformation unit and SPC and SFC functions are used to create, shape, steer effects and extended, desirable, feedback using different algorithms using modelled, calculated or measured data input or sensor signals or otherwise obtainable information or signals.

In the following some examples on desirable steering effects will be given. It should be clear that these examples are not given for limiting purposes, on the contrary, there may also be many other desirable steering effects.

One example of a desirable steering effect is a counter steer effect for braking stability in a curve, i.e. a counter steer effect for reducing the steer angle when the brakes are applied. The SPC function (angle controller) in the ECU 5 will reduce the steer angle when braking in a curve is detected. The SPC function will detect braking by monitoring one or more sensors in combination, e.g. one or more of the switch for brake pedal application (the brake pedal sensor 15), a brake pressure sensor, (ABS) wheel speed sensors, a longitudinal acceleration sensor, a pitch gyro sensor and positioning sensors like GPS, sensors forming part of the sensor cluster 16. That the vehicle is running in a curve will be detected from monitoring one or more sensors in combination, e.g. ABS, e.g. wheel speed sensors, lateral acceleration sensor, yaw rate gyro sensor, steering wheel angle sensor 4, and steering wheel torque sensor 4. The steering wheel actuator 3 can simultaneously be programmed to either replicate steering wheel feedback similar to a mechanical connected system or exaggerate or reduce the feedback or eliminate the feedback.

A simplified schematic example of an algorithm for providing a desired steering effect therefore schematically can be expressed as the steering effect, e.g. added steering angle, is a product of lateral acceleration multiplied with the deceleration of the vehicle and multiplied with a constant. By setting the sign of the constant it can be assured that the added steering effect goes in the correct, desired, direction, i.e. in this case reduces the steer angle, and by varying the amount of the constant the amount of the steer effect can be tuned to achieve stability.

Another example of a similar desirable steering effect is retardation in a curve but without application of the brake pedal. In this case signals from brake pedal application and brake pressure sensors are not used to create a desired steer effect, but rather speed changes or the position of the accelerator pedal. The desired steer effect can be a counter steer effect to improve stability, typically at higher speeds. A desired steer effect may alternatively be an increasing steer effect that improves the turn-in performance of the vehicle, typically at lower speeds. The steer effects can be of feed forward type or as closed loops to obtain a more precise vehicle state.

Still another exemplary desirable steering effect concerns braking at split-mu, i.e. when the wheels on one side of the vehicle have a good grip and the wheels on the other side of the vehicle have a poor grip, the different brake force from left to right side will create a turning moment on the vehicle in the direction towards the side with a good grip. In this case it is desirable to have a steer effect to the side with poor grip to counteract the turning moment to achieve the path that the driver is indicating by the input to the steering wheel 1. The angle controller in the ECU 5 will add the counteracting steer angle when braking on split-mu is detected. The SPC functions (angle controller functionality) in the ECU 5 will detect braking by monitoring one or more sensors in combination. Involved sensors, i.e. sensors from which input signals are used in the ECU SPC algorithms, are e.g. one or more of the switch for brake pedal application, brake pressure sensors, (ABS) wheel speed sensors, longitudinal acceleration sensor, pitch gyro sensor and positioning sensors like GPS.

Yet another steering effect that may be desirable is a steering effect for good turn-in, i.e. making a step steer input on the steering wheel, and to achieve a higher steered wheel response in the transient phase than steady state cornering. This will make the car feel more responsive since phase lags between steering input and response in the vehicle will be lower. The traditional way of achieving this is to have some roll understeer coming from the suspension geometry during roll which reduces the steered wheel angle when the vehicle rolls, i.e. leaning to one or the other side. The drawback is that this typically leads to toe-in changes when going over bumps etc. that can cause course instability. Since it also relies on the roll angle of the vehicle, it can be hard to get the desired effect since it is also desirable to have a flat vehicle behaviour, i.e. low roll angle when cornering. With a steering effect the steered wheel angle can be set higher for the transient cornering phase and lower for steady state cornering without have disturbing steer effects for other conditions. According to the invention The ECU 5 SPC function will detect transient cornering by monitoring one or more sensors in combination, e.g. one or more of steering wheel angle sensor, steering wheel torque sensor, lateral acceleration sensor, yaw rate gyro sensor. The desired turn-in steering effect, as described above in this paragraph, can be speed dependent by also using the vehicle speed information from (ABS) wheel speed sensors and/or positioning data from a positioning system, e.g. GPS.

An example of a desirable extended steering feedback is when the car drives over an unsymmetrical road disturbance, i.e. when the road wheels are affected with a time difference, with a sudden raise or drop in vertical height. It can e.g. come from a manhole, a repair patch in the asphalt or a difference in height between concrete blocks. This will create a short difference in the speed signal from the ABS sensors and this difference can be transformed into a force and or a movement in the steering wheel 1. Another option to have this feedback is to monitor a roll rate sensor and then transform this signal into a steering wheel force and/or movement. A third way to recreate a steering wheel feedback is to monitor the steering rack current and transform it to a force and/or a movement in the steering wheel.

A simplified schematic example of an algorithm for providing extended steering feedback can schematically be expressed as the extended steering feedback, i.e. added steering wheel torque, being a product of roll acceleration multiplied with a constant. By setting the sign of the constant it can be assured that the extended steering feedback goes in the correct direction and by varying the amount of the constant the amount of the extended steering feedback can be tuned.

The inventive concept can be described as providing a virtual mechanical connection through which desired extended feedback and/or steering effects (also denoted steer effects) are created with software functions, whereas undesired extended feedback and/or steer effects are cancelled, i.e. not created. The functions are created using modelled, calculated, or measured data. The functions are not limited to recreation of or cancelling of steering effects and/or extended feedback otherwise coming from a mechanical connection but in addition can also provide steering effects and/or feedback effects not possible to achieve with a mechanical connection. The data, signals, used can be any combination of available signals in the vehicle, signals from available sensors also used for other purposes and/or from specific sensors for steering effects or feedback.

According to the invention the steering effects are not limited to act on the (front) steered wheels, but may act on any wheel having a steering actuator to be controlled; i.e. also not steerable wheels may be provided with, or connected to, and controlled by, a steering actuator. The steering effects can thus be provided to one or more wheels or to all wheels as long as the wheels are connected to a steering actuator. The steering effects may also create a vehicle response by braking or applying drive torque to individual steering elements, e.g. road wheels, all road wheels or some road wheels, or by any other means that can affect vehicle response.

Thus, according to the invention, steering effects and/or extended feedback are/is created and provided to one or more steering elements, e.g. road wheels, by means of a steering actuator 8 (or more steering actuators) as described above instead of only providing basic feedback or solely relying on electric current of an assistance motor to make an interpretation to force to provide extended feedback.

FIG. 2 is a very schematic block diagram illustrating one example of an ECU 5 as in FIG. 1 indicating functions relevant for the inventive concept. Other functions of an ECU which are known per se and which, in addition, can be implemented in different ways are not illustrated.

As also discussed above, information and data are received as input over a sensor and signal interface 51 of ECU 5. The information comprises data and information driver input, information of vehicle state and state of steered elements and e.g. comprises data and information provided by one or more of sensors 4,13,14,15,16,17 and information and data available in other ways, e.g. calculated or modelled, or via a wired data network or via wireless communication e.g. from external units.

As also discussed above, information or values of one or more desired parameters, e.g. vehicle state values, driver input, and state values of steered or not steered steering elements, e.g. road wheels, can also be calculated depending on what sensors are provided and used in particular embodiments, and that for providing a desired steer effects and/or desired extended feedback, information that is available is used; with an extensive set up of sensors, much data and information will be provided directly, whereas in other implementations, sensor values from available sensors are used for calculation of other data and information needed to the extent possible. The input data and information received over sensor and signal interface 51 is provided to a transformation unit 52 comprising processing means and transfer or transformation software for transforming the input to commands to be provided to the SPC 53 and to SFC 54 for execution of the commands and providing actuator activations.

SPC 53 executes steering position control commands and provides actuator activation signals (control currents) to one or more steering actuators 8 to control the steering angle of steering elements 101,101, whereas SFC 54 executes steering feel control commands and provides actuator activation signals (control currents) to steering wheel actuator 3.

The control currents provided to the steering actuator 8 and steering wheel actuator 3 are monitored by the ECU.

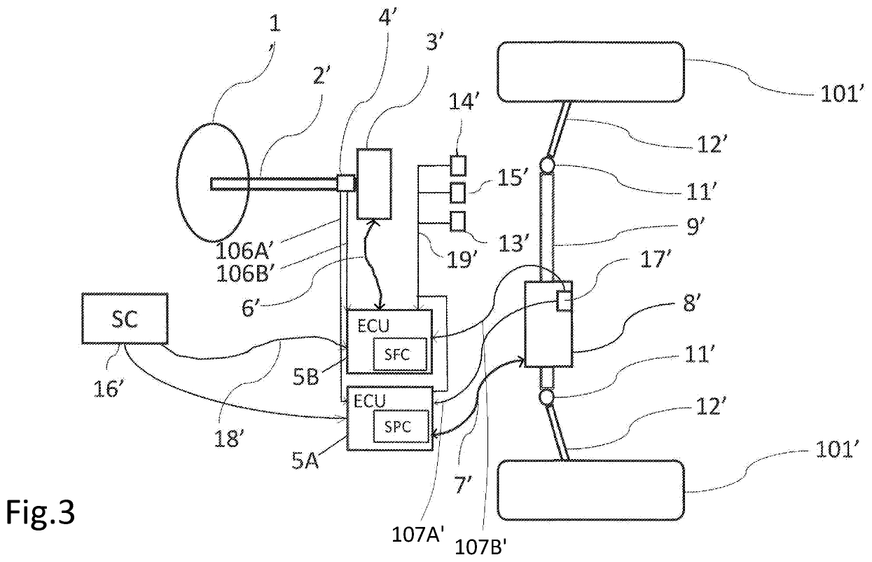

FIG. 3 schematically illustrates an alternative embodiment of a steering system 100′ which differs from the steering system 100 shown in FIG. 1 in that it comprises two ECUs 5A, 5B wherein ECU 5A comprises the SPC functions 53′ executing steering position control commands whereas ECU 5B comprises the SFC functions 54′ executing steering feel control commands received from a respective transformation unit, or from a common transformation unit. In other respects the functions and elements correspond to what is described above and with reference to FIGS. 1 and 2, and corresponding features and elements bear the similar reference signs but provided with a prime and will not be further described herein. It should be clear that different functionalities may be provided in a common ECU or in different ECUs, also more than two ECUs and the invention is not limited to any specific implementation.

An advantage with using one combined, or common, ECU is that it can be made more cost efficient than if two separate ECU:s are used. This could be suitable where both steering actuator and steering wheel actuator are close to each other and placed inside the driving compartment. In another case where the steering actuator is placed outside of the compartment, subjected to harsh outside conditions, it can be advantageous to have e.g. two separate ECU:s. One ECU inside with lower grade and lower cost and another ECU outside with higher grade and higher cost. Having the ECU separated and closer to each actuator will also reduce high current wire length and thus the electrical losses.

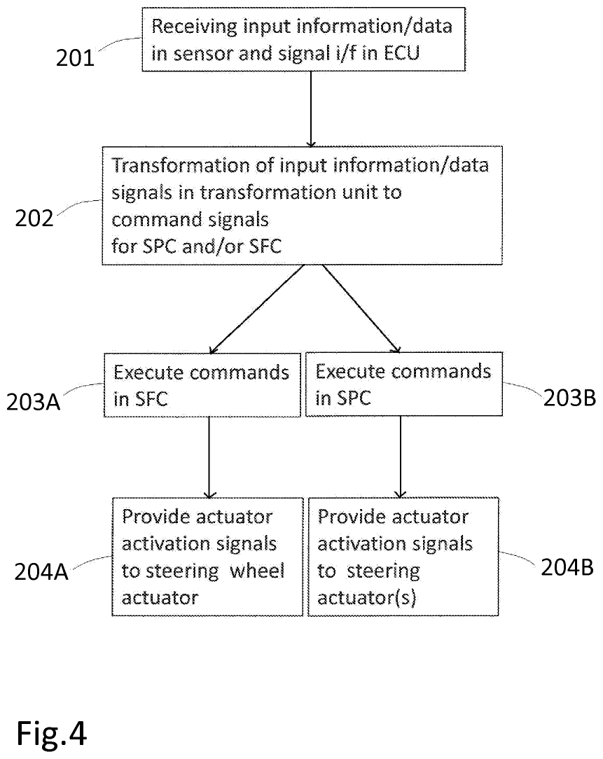

FIG. 4 is a schematic flow diagram describing steering control in a Steer-by-Wire steering system creating steering effects and/or extended feedback according to the present invention.

In a first step, 201, data and information is received over a sensor and signal interface in a ECU; information such as information regarding driver input, vehicle state and steering arrangement (here steering wheel) state, from a number of sensors, but also otherwise available information and calculated information, e.g. from sensor cluster SC 16 (e.g. about vehicle velocity in direction x, acceleration in directions x,y, yaw rate, roll rate, wheel speed (ABS), from pedal sensors 13, 14, 15; e.g. accelerator position, brake position, clutch position, from steering sensors, e.g. torque and/or angle sensors 4, and from steering gear sensors, e.g. angle and/or current sensors 17 via (here electric) connections 18, 19,106, 107 respectively.

In step 202 the input is provided to a transformation unit comprising transformation or transfer function software for, depending on input transforming the input to commands for execution.

Steering feel control commands are provided to SFC 54 for execution, 203A and steering position control commands are provided to the SPC 53 for execution, 203B.

In SFC 53 executed steering feel commands are provided to steering wheel actuator 3 as steering wheel actuations, 204A via (here electric) connection 6.

In SPC 54 executed commands are provided to one or more steering actuators 8 as steering actuations, 204B via (here electric) connection 7.

SFC functions and SPC functions comprising respective algorithms for executing received commands and providing respective actuator activations may be provided in a common ECU 5 or in different ECUs (not shown) in different embodiments.

It should be clear that only examples on sensors and information are given. In different embodiments some of these sensors may be used, others not, and still other sensors and other data as well may be used. The number of actuators may also vary as well as the types of actuators. It is also possible to, for one or more parameters instead of using measured data, which e.g. is not available depending on what sensors are implemented, use calculated and/or modelled data (e.g. from one or more other sensors or otherwise available data), i.e. sensed and/or calculated or modelled data, data obtained directly from sensors and/or indirectly obtained data.

In a conventional car there are typically several steer effects occurring from the suspension and steering geometry design due to for example forces acting on the road wheels. When a force acts at the wheel at contact patch with ground in a lateral direction it will create a steer effect of the wheel which often is called a toe change. Such toe changes are typically not unwanted or minimized, but instead designed to react with certain value depending on the force. In this way the behaviour of the car can be tuned to certain responses in different driving situations which are important for achieving desirable driving characteristics and thus a part of the overall driving experience.

Other steer effects that also are possible to tune are for example a toe change as a result of longitudinal force in the contact patch and toe change resulting normal force. Normal force changes typically make the wheel also move considerably in the Z direction for example when the car drives over a bump or when it rolls during cornering. These toe changes are typically rather small by practical mechanical reasons and a desired amount of toe change in one situation can be unwanted amount of toe change in another situation, for example a certain amount of toe change has a very small effect at low speeds but at the same time it could be overwhelming at high speeds. One example is to design a toe change that during cornering makes the car turn in even more when the driver increases the steering input. This extra turn in is often highly regarded by enthusiast drivers since the car then feels very agile. If this toe change is designed for lower speeds it has to be quite large to give a substantial effect resulting in that the toe change induced turn in is too high for higher speeds and make the car feel very nervous or even unsafe. So the toe changes typically kept rather small to not let them be hazardous in certain situations. The denotation of the steer effects as toe changes in itself indulges that they are rather small.

The present invention is not limited to small steer effects, and the term toe changes is therefore not used, but rather the more general terms steer (or steering) effects are used to make it clear that the size of effects may be small as well as large.

It is an advantage of the present invention that it is possible to design appropriate amounts of steer effects for many different situations, in general for every situation, since the effects are created with programmable functions that use signals, data, calculations and models and information and about vehicle state, steering element state and driver intentions is recognized and used.

As an example, the steering effects can be made small for high speed driving in order not to upset stability or driving safety while the steer effects can be made large in lower speeds in order to have a significant contribution to turn in, and thus enjoyment of driving.

Through the inventive concept thus not only different amounts of steer effects can be provided, but it also allows for a partial or even a total cancellation of steer effects, and steer effects can be given opposite values. For example, in this way turn in can be actively improved at lower speeds while at higher speed stability can be actively improved.

It is also an advantage of the present invention that a very high degree of design freedom is allowed since the relationships between forces acting on the wheel and resulting torque and/or movements in the steering wheel are mechanically decoupled and then determined in programmable function different from in a conventional car with conventional suspension and steering system, wherein toe changes, caused by forces acting on a wheel, can be more or less heavy associated with torque and/or movements in the steering wheel and this typically depends to a large extent on what lever the acting force will have around the steering axis. This relation between acting force and the lever around the steering axis is set in the design process and will then influence all the relations between forces acting on the wheel and resulting torque and/or movements in the steering wheel.

As an example, in a traditional car, when driving over a one side obstacle, such as a manhole, the impact to the wheel will generate some toe change and some steering wheel reaction, dependent on the actual suspension and steering design. For a luxury car it can be assumed that both toe change and steering wheel reaction is designed to be low, so as not to upset the driver. For a sporty car the manufacturer might want to transmit some reaction into the steering wheel to generate a feeling to the driver that there is an intimate connection between what happens at the wheels and what can be sensed in the steering wheel and at the same time it can be desired not to have a toe change since this can corrupt directional stability. These two goals are typically contradictory in traditional mechanical design, but with the present invention it is fully possible to achieve both. It is also possible to have different steering wheel reactions and steer effects in the same car and for example switch between them with a drive mode selector that are common in many cars.

It is also an advantage of the invention that since steer effects are created with functions controlling the wheel angles with a steering actuator, the suspension can be made more rigid and thus allowing for a more direct steering response than for conventional traditional cars wherein steer effects often form part of mechanical design and suspension, and steering design involves many parameters to be optimised and compromised to achieve the desired driving characteristics. For example, the elasto-kinematics of a traditional suspension and steering will generate certain toe changes, but often at the trade off with elasticity in the wheel suspension that will cause a less direct steering response.

It should be clear that the inventive concept also covers embodiments with a steering arrangement comprising for example a yoke, joystick or any other input device instead of a steering wheel and the inventive concept as described above is applicable for providing desired steering effects, desired feedback for steering and steering effects for steering of different vehicles such as, in addition to cars, trucks, buses, but also other vehicles such as aircrafts, boats, remotely operated vehicles and radio-controlled models and toys. It can also be used for steering of vehicles in simulators and computer games while providing desired feedback, steering effects and/or extended feedback. Thus vehicle and driver are to be interpreted in a broad sense.

It should be clear that the invention is not limited to the specifically illustrated embodiments, but that it can be varied in a number of ways within the scope of the appended claims.

1-21. (canceled)

22. A power assisted steering system for a vehicle, comprising a steering arrangement, a steering shaft connected to the steering arrangement, steering elements, at least some of which steering elements being steerable, a controllable, preferably electrically, steering actuator connected to one or more of the steering elements, at least one steering arrangement actuator connected to the steering arrangement controlling feedback to the steering arrangement and an Electronic Control Unit, ECU, arrangement comprising at least one ECU controlling the steering actuator and the steering arrangement actuator, said ECU arrangement comprising a sensor and signal interface and a transformation unit for performing a transfer between an angle of the steering arrangement and angle(s) of steered steering elements, the steering system further comprising a number of sensors collecting information allowing determination of at least one or more of vehicle velocity, steering torque and/or steering angle of the steering arrangement and steering element angle, wherein said sensor and signal interface is arranged to receive at least information regarding, or allowing calculation of, one or more of a vehicle state, a subsystem state and driver input, said information at least comprising information regarding, or allowing calculation of vehicle velocity, steering arrangement steering torque and/or steering angle, steering element angle(s), from one or more of the sensors connected via connections to said sensor and signal interface, that said ECU arrangement comprises a steering feel control function, SFC, and a steering position control function, SPC, said ECU arrangement being arranged to provide said received input information to the transformation unit, and in that the transformation unit is arranged to, by means of processing means, transform the received input information to steering feel control commands and to steering position control commands, and to provide the steering feel control commands to the steering feel control function, SFC, and to provide the steering position commands to the steering position control function, SPC, that the steering feel control function, SFC, is adapted to execute the received commands and to provide the executed commands as actuator activation signals to the steering arrangement actuator to provide an extended feedback, and that the steering position control function, SPC, is adapted to execute the received commands and to provide the executed commands as actuator activation signals to one or more steering actuators, to provide steering effects.

23. The power assisted steering system according to claim 22, wherein the at least some steering elements comprise steerable wheels, e.g. front and/or rear suspension wheels, and that said at least one steering actuator is directly or indirectly connected to one or more steerable wheels.

24. The power assisted steering system according to claim 22, wherein it comprises at least two steering actuators connected to different steering elements, steerable and/or non-steerable.

25. The power assisted steering system according to claim 22, wherein the input signals from one or more of the sensors comprise directly via the sensors sensed values and/or calculated and/or modelled data e.g. from one or more other sensors or otherwise available data, i.e. sensed and/or calculated or modelled data, data obtained directly from sensors and/or indirectly obtained e.g. via a wired data network or via wireless communication from external units, for transformation, by means of calculations and/or lookup tables in the transformation unit, to provide command signals for execution in the steering feel control function, SFC, and/or in the steering position control function, SPC.

26. The power assisted steering system according to claim 22, wherein the system further comprises a link arrangement connected to one or more steering elements and in that the at least one steering actuator is arranged on or connected to said link arrangement for controlling said steering elements.

27. The power assisted steering system according to claim 26, wherein the link arrangement comprises a track rod arrangement or a steering rack via steering rods connected to the steering elements.

28. The power assisted steering system according to claim 22, wherein the at least one vehicle state comprises at least one or more of steering element, e.g. wheel, speed, vehicle angular speed around an axis in yaw, pitch or roll direction, acceleration in longitudinal direction relating to a vehicle axis in the horizontal plane and in the forward direction of travel, in lateral direction in the horizontal plane, perpendicular to the longitudinal direction or vertical direction pointing upward from the horizontal plane, vehicle position.

29. The power assisted steering system according to claim 22, wherein the at least one subsystem state comprises at least one or more of a steering element position and/or a steering element angle and/or a steering element velocity, steering actuator position, brake pedal position and/or brake pedal force, and/or brake pedal pressure, steering arrangement angle and/or steering arrangement (steering wheel) torque, clutch pedal position and/or a clutch pedal force, accelerator pedal position and/or force.

30. The power assisted steering system according to claim 22, wherein the driver input information comprises at least one or more of information relating to steering arrangement torque and/or angle, brake pedal position, brake pedal pressure, accelerator pedal position, clutch pedal position.

31. The power assisted steering system according to claim 28, wherein the systems comprises one or more of a steering arrangement torque and/or angle sensor), an ABS sensor or wheel speed sensor, a rate gyro sensor, an acceleration sensor, a position sensor, e.g. a GPS, a brake pedal sensor, a brake pressure sensor, an accelerator pedal sensor, a clutch pedal sensor and steering gear sensors comprising angle and/or current sensors for sensing and monitoring one or more of the vehicle states, subsystem states and driver input.

32. The power assisted steering system according to claim 22, wherein the transformation unit comprises software with algorithms, for, using available or modelled, calculated or measured data input or sensor signals, for via the command signals to SPC and SFC functions create and/or shape steer effects and extended feedback hence allowing provisioning of desired additional steer effects, also allowing for partial or even a total cancellation of steer effects, and steer effects can be given opposite values and/or extended feedback depending on algorithms and available information.

33. The power assisted steering system according to claim 22, wherein it comprises a common ECU comprising the SPC functions as well as the SFC function.

34. The power assisted steering system according to claim 22, wherein it comprises at least two ECUs, one of the ECUs comprising the SPC function and another ECU comprising the SFC function.

35. The power assisted steering system according to claim 22, wherein the steering arrangement comprises a steering wheel.

36. The power assisted steering system according to claim 22, wherein the steering arrangement comprises a joystick, a yoke or any other appropriate input device.

37. The power assisted steering system according to claim 22, wherein it comprises a steer-by-wire steering system or a wireless steering system.

38. A steering system arrangement for a power assisted vehicle steering system comprising a steering arrangement, a steering shaft connected to the steering arrangement, a controllable, e.g. electrically, steering actuator for controlling steering elements, a steering arrangement actuator connected to the steering arrangement and an Electronic Control Unit, ECU, arrangement comprising at least one ECU for controlling the steering actuator and the steering arrangement actuator which are connected to the ECU arrangement via one or more connections, the ECU arrangement comprising a sensor and signal interface and a transformation unit, characterized in that the sensor and signal interface is arranged to receive information from one or more sensors at least regarding, or allowing calculation of one or more of a vehicle state, a subsystem state and driver input, said information at least comprising information regarding, or allowing calculation of vehicle velocity, steering arrangement steering torque and/or steering angle, steering element angle(s), that said ECU arrangement comprises a steering feel control function, SFC, and a steering position control function, SPC, and is arranged to, in a transformation unit transform the received input information to steering feel control commands and to steering position control commands, and to provide the steering feel control commands to the steering feel control function, SFC, and to provide the steering position commands to the steering position control function, SPC, that the steering feel control function, SFC, is adapted to execute the received commands and to provide the executed commands as actuator activation signals to the steering arrangement actuator to provide an extended feedback, and that the steering position control function, SPC, is adapted to execute the received commands and to provide the executed commands as actuator activation signals to one or more steering actuators (8;8′) to provide, create, and/or tune created steering effects.

39. The steering system arrangement according to claim 18, wherein it further comprises a number of steering elements, at least some of which being steerable, and at least some of which being connected to the steering actuator.

40. The steering system arrangement according to claim 18, wherein it is adapted for providing extended feedback and/or at least steering effects in a steer-by-wire steering system or a wireless steering system.

41. A method in a steer by wire or wireless power assisted steering system for a vehicle comprising a steering arrangement, a steering shaft connected to the steering arrangement, steering elements, at least some of which steering elements being steerable, a controllable, e.g. electrically, steering actuator connected to one or more of the steering elements, at least one steering arrangement actuator connected to the steering arrangement and controlling feedback to the steering arrangement and an Electronic Control Unit, ECU, arrangement comprising at least one ECU controlling the steering actuator and the steering arrangement actuator, said ECU arrangement comprising a sensor and signal interface and a transformation unit for performing a transfer between an angle of the steering arrangement and angle(s) of steered steering elements, the steering system further comprising a number of sensors collecting information allowing determination of at least one or more of vehicle velocity, steering torque and/or steering angle of the steering arrangement and steering element angle, wherein it comprises the steps of: receiving or collecting information via the sensor and signal interface regarding, or allowing calculation of, one or more of a vehicle state, a subsystem state and driver input, said information at least comprising information regarding, or allowing calculation of vehicle velocity, steering arrangement steering torque and/or steering angle, steering element angle(s), from one or more of the sensors providing said received and/or collected information to the transformation unit, transforming, by means of processing means, received or collected information and/or calculated information in the transformation unit to steering feel control and/or steering position control command signals, providing steering feel control commands to a steering feel control function, SFC, in the ECU arrangement, providing steering position control commands to a steering position control function, SPC, in the ECU arrangement, executing the received steering feel control commands in the SFC and providing the executed steering feel control commands to the steering arrangement actuator to provide extended feedback, executing the received steering position control commands in the SPC and providing the executed steering position control commands to one or more steering actuator(s), to create steering effects and/or extended feedback and/or tune created steering effects and/or extended feedback.

42. The vehicle comprising a wired or wireless steering system according to claim 22, wherein the vehicle is a car, a bus, a truck, an aircraft, a boat, a remotely operable vehicle, a vehicle in a simulator or in a computer game.
